(19) United States
(12) Patent Application Publication
(10) Pub. No.: US 2023/0055238 A1
(43) Pub. Date: Feb. 23, 2023

(54) SYSTEM AND METHOD OF VEHICLE RISK ANALYSIS

(71) Applicant: Po-Yuan Chen, New Taipei City (TW)

(72) Inventor: Po-Yuan Chen, New Taipei City (TW)

(21) Appl. No.: 17/707,865

(22) Filed: Mar. 29, 2022

(30) Foreign Application Priority Data
Aug. 19, 2021 (TW) 11030707

(51) Int. Cl. G06Q 40/08; B60W 60/00; B60W 50/14; B60W 40/09

(52) U.S. Cl. CPC G06Q 40/08; B60W 60/0059; B60W 60/00186; B60W 50/14; B60W 40/09; B60W 2050/146; B60W 2540/30

(57) ABSTRACT

A vehicle risk analysis system, includes: a historical database, storing the sensing data and accident records acquired from multiple sampled vehicles into big data; a learning unit, connected to the historical database for analyzing the relationship between accident records and driving scenarios, to generate a risk classification model, which can further predict the risk of accidents for a vehicle in-use; and a risk profiling unit, receiving the risk classification model from the learning unit and acquiring the sensing data from the vehicle in-use, to generate a risk profile for the vehicle in-use under different driving modes. The risk profile reports the expected risks of accidents under different driving modes by using the occurrence rates for different driving scenarios and the expected losses of money caused by accidents, wherein each of the driving scenarios can be determined by a combination of the sensing data. The system can suggest an optimal driving mode for the vehicle in-use by using the risk profile, which can be further used to price the insurance premiums under different driving modes.

### CROSS REFERENCE

THE present invention claims priority to TW 110130707, filed on 19 Aug. 2021.

### BACKGROUND OF THE INVENTION

### Field of Invention

The present invention relates to a vehicle risk analysis system, which specifically determines the expected risks of accidents under different driving modes by analyzing the relationship between driving scenarios and vehicle accidents, using real-time sensing data collected from sampled vehicles.

### Description of Related Art

Historical data, stored as big data, can be aggregated as large and complicated information, which is difficult to analyze by traditional data processing techniques. Namely, big data can be used to find the causality among events; for example, it can be used to predict business trends, determine the rules of quality control, predict diseases spread trends, and find the clues against crimes, etc.

In the current vehicle-related field, a lot of suppliers focused on non-statistical techniques. That is, they are not really interested in developing new technical applications using the massive data of vehicle accidents.

On the contrary, they concentrate on finding a new technology, based on simulation models with reference to little vehicle accidents, to introduce new technical functions for new vehicles in order to catch people's eyeballs and thus earn more profits. At present, little devices are used to continuously collect real-time vehicle operation data, and find the association between vehicle operations and accidents.

Regarding the fault allocation for vehicle accidents, vehicle manufacturers usually state that existing vehicles equipped with safety devices are only for assisting operators to operate safely, but not for dominating the vehicle driving activities. In other words, these safety devices are auxiliary and operators should be responsible for any vehicle driving fault. However, most of the operators do not understand how these safety devices work, neither can they learn such knowledge from vehicle driving courses as usual. For example, operators scarcely understand the details about how these safety devices work to distribute the wheel brake forces on wheels when they drive on an icy road, neither the mechanism of the airbag reaction into explosion, nor the details of other safety devices. Even so, these safety devices still significantly influence the vehicle driving behaviors when in operation; especially, at the time when the accidents are about to happen. So far, there has been little technologies for systematic assessment/evaluation concerning how these safety devices work in vehicle accidents. The parameters of these safety devices are usually set according to vehicle manufacturers' subjective understanding of how to avoid the vehicles from driving danger, and how to reduce the impacts of accidents, or tuning engineers' personal understanding of how to avoid/reduce dangerous driving behaviors. Importantly, this kind of understanding is possibly biased with reference to limited vehicle accidental information. Therefore, technology of methodical analysis based on vehicle accident records is essential for evaluating and improving these safety devices. Furthermore, this information is highly relevant to insurance, such that it is not only a technological issue but a financial topic. For insurance companies, it is important to have an accurate evaluation tool to assess operators' risks and price their insurance premiums based on statistical information acquired from the massive driving data.

According to the traffic regulations in some countries, driving image recorders are required on high weighted vehicles (e.g., truck, bus, or trailer) to serve for accident fault allocation (main liability for accidents). However, the perspective view of the driving image recorders might be insufficient to completely rebuild the accident scene (for example, lacking lateral view for recording impact from laterally coming vehicle). Besides, memory card error, high working temperature under bright sunlight, strong impact, and unstable power source might cause the driving image recorders to function improperly. Therefore, the information provided by the driving image recorders is usually not enough to completely and successfully assess the vehicle accidents.

Therefore, a technology for systematically determining the accident liability and statistically evaluating the capability of safety systems in vehicle accidents is extremely crucial for insurance premium pricing, liability allocation, and the improvement of safety systems.

### SUMMARY OF THE INVENTION

The present invention provides a vehicle risk analysis system, for determining the expected risks of accidents under different driving modes by using occurrence rates and severity of damage under different driving scenarios based on real-time sensing data collected from sampled vehicles, wherein the risk classification model is obtained by analyzing the relationship between driving scenarios and vehicle accidents.

In view of the above, the present invention provides a vehicle risk analysis system, which includes: a historical database, storing real-time sensing data and accident records collected from multiple sampled vehicles into big data; a learning unit, connected to the historical database for analyzing the relationship between accident records and driving scenarios using a risk classification algorithm, to generate a risk classification model, wherein each of the driving scenarios can be defined by a combination of the sensing data; and a risk profiling unit, receiving the risk classification model from the learning unit and the sensing data of the vehicle in-use, to generate a risk profile of the vehicle in-use under three different driving modes: Human Control, Autonomous, and Hybrid.

In one embodiment, the historical database is used to store the real-time sensing data, driving mode and time-domain information, as well as vehicle accident records, which can be used in the information analysis for the present invention. A risk classification algorithm is used to find the relationship between driving scenarios and vehicle accidents. After the completion of the algorithm, a risk classification model is obtained, which can be deployed to map the sensing data of the vehicle in-use to its risk profile under different driving modes.

In one embodiment, the risk profile generated by the vehicle risk analysis system can be used to suggest an optimal driving mode for the vehicle in-use. In the present invention, the optimal driving mode can be determined by comparing the expected risks of accidents under different driving modes. It is one of the following options: human control mode, autonomous mode, and Hybrid mode (switches between human control and autonomous modes). Therein, the human control mode is a mode wherein human operators are fully in charge of controlling the vehicles, the autonomous mode is a mode wherein the devices are automatically in charge of controlling the vehicles, and the hybrid mode is a mode wherein mode-switching events occur when vehicles are in operation.

In one embodiment, the risk classification algorithm can be used to determine the sensitive driving scenarios (major driving scenarios), which are critical in the vehicle accidents. The risk classification algorithm can analyze the relationship between vehicle accidents and driving scenarios under different driving modes. The sensitive driving scenarios are those resulting in higher level of severity of damage, loss of property, loss of money, and serious injuries.

In one embodiment, a plurality of driving scenarios (including sensitive driving scenarios) are provided, such as: a distance sensed between the vehicle in-use and a front object (or front obstacle), sudden and extensive vehicle acceleration change, a difference between braked wheel speeds, a difference between speeds of not-braking wheels, a difference between vehicle yaw angle and corresponding steering angle, a vehicle in a hazardous area, over speeding, overdriving (changing lane to get ahead of other vehicles in a neighboring lane), vehicle mechanical component health condition, and vehicle maintenance records.

In one embodiment, the distance between the vehicle in-use and a front object (or front obstacle) can be determined by comparing sensing results of a LIDAR (light detection and ranging) and an image sensing. The final sensing results can be obtained by implementing a sensor fusion algorithm.

In one embodiment, a driving period is a period for storing the sensing data collected from the vehicle in-use. It can be measured by driving distance or driving time.

In one embodiment, the risk profile of the vehicle in-use contains the expected risks of accidents under different driving modes. It can be further used to price the insurance premiums for the vehicle in-use.

In one perspective of the present invention, a vehicle risk analysis method is provided to include: storing the real-time sensing data and accident records collected from multiple sampled vehicles into big data; analyzing the relationship between accident records and driving scenarios using the big data, to generate a risk classification model validating the relationship between driving scenarios and vehicle accidents, wherein each of the driving scenarios can be defined by a combination of the sensing data; and generating a risk profile for the vehicle in-use.

### BRIEF DESCRIPTION OF THE DRAWINGS

For a better understanding of the above and other aspects of the present invention, the following detailed description of the embodiments with reference to the figures.

FIG. 1 illustrates one embodiment of the vehicle risk analysis system according to the present invention.

FIGS. 2, 3, and 4 respectively illustrate several embodiments of determining an optimal driving mode in the vehicle risk analysis system of the present invention.

FIG. 5 illustrates operation between the vehicle yaw angle and steering angle according to one embodiment of the present invention.

FIG. 6 illustrates one embodiment of the vehicle risk analysis system according to the present invention.

### DESCRIPTION OF THE PREFERRED EMBODIMENTS

The objectives, technical details, features, and effects of the present invention will be better understood with regard to the detailed description of the embodiments below, with reference to the drawings.

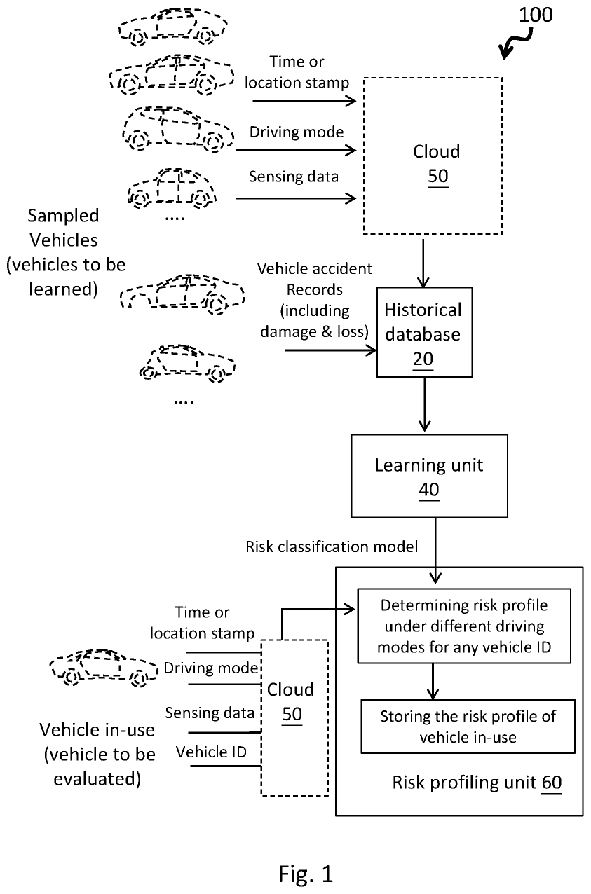

In one perspective as shown in FIG. 1, the present invention provides a vehicle risk analysis system 100, which includes: a historical database 20, a learning unit 40, and a risk profiling unit 60. The historical database 20, is configured to store the real-time sensing data and accident records collected from various sampled vehicles into big data, wherein the sensing data and accident records are stored in a historical database 20 and received via a cloud 50, other information media, or received directly from the vehicles without going through the cloud 50. The learning unit 40, is connected to the historical database 20 for analyzing a relationship between accident records and driving scenarios using a risk classification algorithm, to generate a risk classification model. Each of the driving scenarios is defined by a combination of the sensing data. For example, some driving scenarios are highly related to vehicle accidents, such as over-speeding driving might result in collision with a front car. In the present invention, the sensing data can be categorized to form driving scenarios with different expected risks of accidents. The risk profiling unit 60, is configured to receive the risk classification model from the learning unit 40 and acquire the real-time sensing data from the vehicle in-use to generate a risk profile for the vehicle in-use under different driving modes.

Importantly, the aforementioned vehicles in the present invention are not limited to cars, they could be in different forms of transportation, such as cruise boat, yacht, drone, and ultra light plane, wherein the corresponding embodiments can be modified within the spirit of the present invention to meet the practical requirement. Further, the present invention provides a driving-mode switching technology for controlling a vehicle manually or automatically, based on the optimal driving-mode decision made by the minimum expected risk of accidents, in terms of severity of damage, loss of money, or insurance premium.

In one embodiment, the historical database 20 is configured to store the sensing data, driving mode information, vehicle accident records (accident type, time, location, severity of damage, loss of property, loss of money, injuries, vehicle type, and operator identification, etc.) to provide information for further analysis. A risk classification algorithm can be used to analyze the relationship between vehicle accidents and driving scenarios to generate a risk classification model, which validates the causality in vehicle accidents. With the risk classification model, the expected risks of accidents can be computed using the corresponding occurrence rates of driving scenarios, severity of damage, and loss of money. Therein, the driving information includes the driving mode (a human control mode, an autonomous mode, and a hybrid mode) when the vehicle in-use is in operation and sends out its sensing data to the system. Further, the expected risks of accidents under different driving modes can be used to find an optimal driving mode.

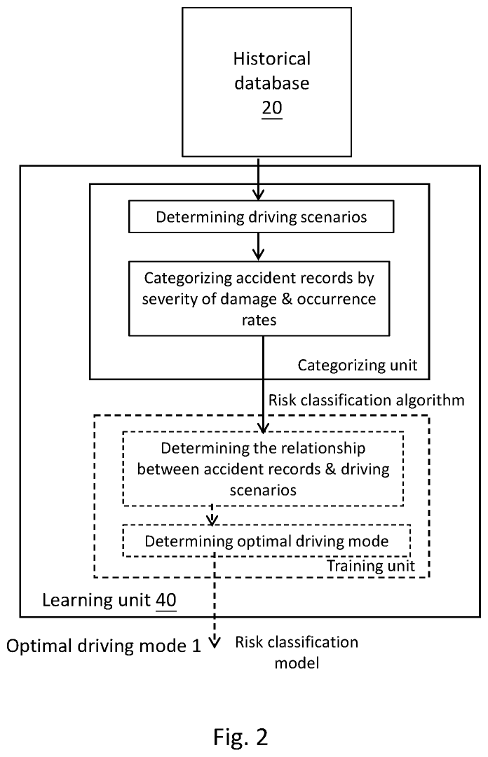

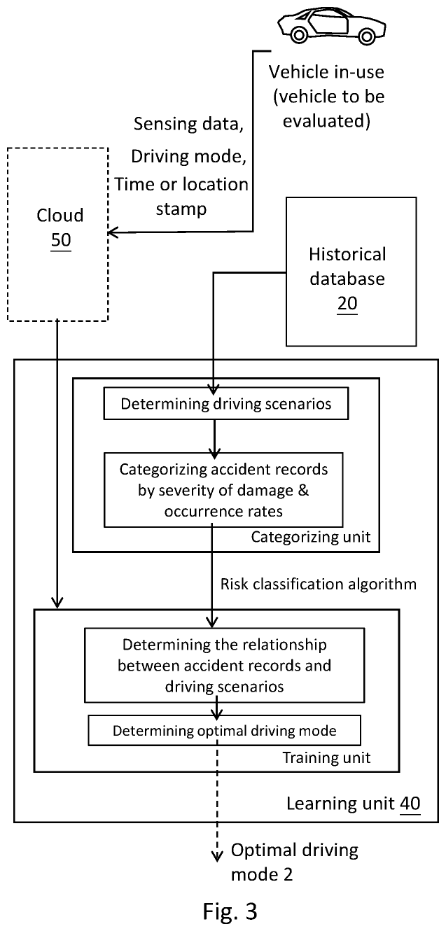

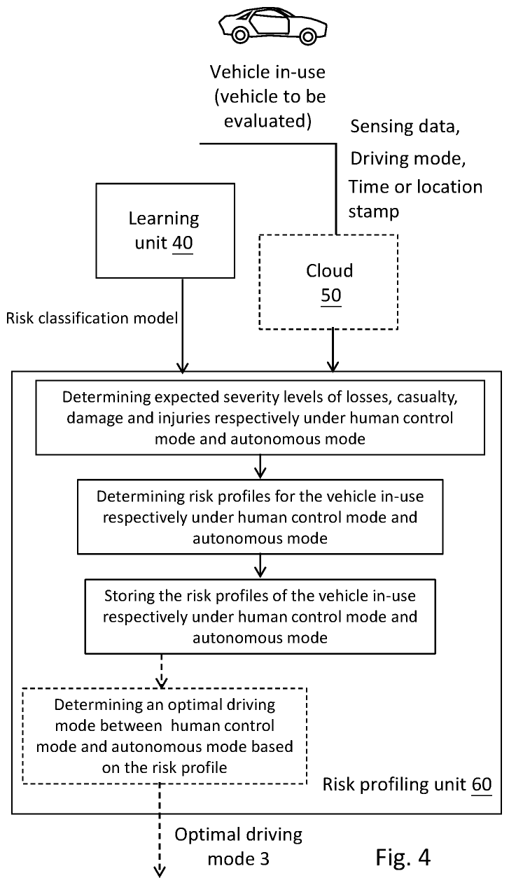

In one embodiment, the vehicle risk analysis system 100 classifies the driving modes into human control, autonomous, and hybrid modes. There might exist some other conditional options, such as a driving mode in specific road conditions. An optimal driving could be determined according to the expected risks of accidents under different driving modes. The derivation of an optimal driving mode could be as follows: using a classification algorithm to analyze the information stored in the historical database 20 (FIG. 2, “optimal driving mode 1”), or using the risk classification model to analyze the sensing data acquired from the vehicle in-use (FIG. 3, “optimal driving mode 2”), or using the risk profile generated from the sensing data of the vehicle in-use (FIG. 4, “optimal driving mode 3”).

In FIG. 2, the optimal driving mode 1, is determined by using a risk classification algorithm to analyze the information stored in the historical database 20. For example, analyzing the most recently recorded sensing data, the optimal driving mode 1 with minimum risk of accidents can be determined. If necessary, more information could be added for analysis. For example, operator's age, educational level, job, marital status, and health condition, etc. Adding more relevant information, the vehicle risk analysis system 100 will predict the expected risk of accidents more accurately. In one embodiment, the optimal driving mode 1 is an initial driving mode, and switchable after the completion of warm-up driving.

In embodiment as shown in FIG. 3, the optimal driving mode 2 of the vehicle in-use can be determined by using the risk classification model to analyze the sensing data acquired from the vehicle in-use. The optimal driving mode 2 can be a lower risk driving mode than driving mode 1. Relevant driving scenarios can be categorized into different levels in terms of severity of damage or loss of property caused by accidents. In other words, the optimal driving mode 2 is a safer driving mode with less risky driving scenarios than driving mode 1. Otherwise, the system will suggest to stay in driving mode 1.

In embodiment as shown in FIG. 4, the optimal driving mode 3 is determined by using the real-time risk profile for the vehicle in-use. This mode can be less risky than driving mode 2 and entitled with lower insurance premium in terms of risk profile for the vehicle in-use. A real-time insurance premium calculation capability could be implemented for the vehicle in-use. The real-time risk profile for the vehicle in-use is the basis for the real-time insurance premium calculation. In this embodiment, the risk profile can be used to price the insurance coverage, such as casualty, damage, or injuries for the vehicle in-use.

In one embodiment, the risk levels can be categorized by accident severity under different driving modes. Sensitive driving scenarios could be identified as major driving scenarios corresponding to major causes of vehicle accidents. A risk classification model can be obtained by analyzing the relationship between accident severity and driving scenarios under different driving modes.

In one embodiment, the sensing data may include: vehicle speed, wheel braking condition, turn signal light condition, steering angle, gyroscope angle, parking alarm light, GPS (global positioning system) location, laser radar sensing distance, reversing alarm light, recorded vehicle outside image, intake air temperature, throttle valve status, cooling water temperature, oxygen sensing signal, crank angle, air flow, knock sensing signal, tire temperature, tire pressure, etc.

In one embodiment, the risk classification model can be obtained by analyzing the relationship between accident records and driving scenarios. At least a portion of the driving scenarios are highly risky and related to vehicle accidents; for example, when the distance between a high-speed driving vehicle and a front object (or front obstacle) is very short, this unsafe distance may easily cause a front side collision. That is, one of the sensitive driving scenarios is the high-speed and short-distance driving. A risk classification model can identify the risk of such an accident (front side collision) caused by this kind of sensitive driving scenario using an algorithm to analyze the historical sensing data and accident records, acquired from sampled vehicles. In one embodiment, the distance can be recorded according to location stamps or GPS signals between two vehicles.

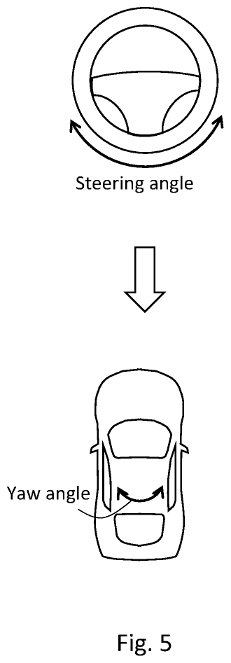

Most operators have their own operational habits. Some of their driving behaviors may causes serious vehicle accidents. There has been little technology developed so far to statistically analyze these behaviors by using the sensing data acquired from the vehicles in accidents. For example, when a vehicle runs in a curve, the operator might get used to driving closer to outside lane (the vehicle possibly hits the outer road fence, which can be sensed by an acceleration sensor and GPS); or, driving too close to a rear end of a front vehicle (distance between the vehicle and its front vehicle is dangerously short) as to cause a front end collision, which can be sensed by an acceleration sensor, LIDAR and an image sensor; or, the operator gets used to taking emergent and extensive braking, possibly causing a rear end collision, which can be sensed by an acceleration sensor and a pedal position sensor; or, the operator gets used to frequently overdriving/changing lanes (easily causing slipping and spinning situation in high speed), which can be sensed at least by a vehicle yaw angle sensor, and steering angle sensors (referring to FIG. 5), etc. The above examples are some evidences for illustrating the relationship between the sensing data acquired under specific driving scenarios and the corresponding vehicle accidents.

In one embodiment, the distance between a vehicle in-use to its front object or obstacle can be determined by comparing the sensing result of a LIDAR (light detection and ranging) with that of an image sensor by using a sensor fusion algorithm. The sensor fusion algorithm is used to validate the sensing results by comparing the sensing data collected from different physical/chemical sensors (based on the same types of physical/chemical properties). For example, the sensing data acquired from the LIDAR and the image sensor, can be processed by a sensor fusion algorithm to improve the accuracy of distance estimation.

In one embodiment, in order to analyze the driving behaviors using the sensing data acquired from the sensors, a plurality of driving scenarios are defined by a plurality of sensing data, such as the distance between a vehicle in-use and its front object or obstacle (moving vehicle, people, animal, static object, or road barrier), a sudden and extensive vehicle acceleration change (causing a front or rear end collision), the difference between braked wheel speeds (at least one wheel skidding), the difference between speeds of not-braking wheels (driving on a road with a combination of slippery, sandy, or dry pavements conditions), the difference between vehicle yaw angle and corresponding steering angle (FIG. 5, the vehicle yaw angle not corresponding to steering angle control, over/under steering, or spinning), a vehicle in a hazardous area (dangerous mountain area, under-construction area, accident-prone area, high criminal area by comparing GPS and hazardous area information stored in the cloud 50), over speeding (poor contact and low friction between the wheel and a road, causing poor braking effect), overdriving (prone to collision, over/under steering, or spinning), vehicle's mechanical component health condition (determined by sensing results, inspection records, or vehicle maintenance records).

Importantly, according to the present invention, the driving scenarios are not limited to the aforementioned examples using single sensing data. In contrast, any combination of the sensing data acquired from sampled vehicles might be highly related to a certain type of vehicle accidents. A risk classification algorithm is used to analyze and discover such a linkage, and the validated result is a risk classification model to be deployed as an accidental risk evaluation framework using sensing data acquired from the vehicle in-use.

In one embodiment, the combination of sensing data can be determined according to functional needs. For example, a driving scenario is defined by a combination of sensing data, including wheel speed, steering angle, acceleration information, and yaw angle. As a second example, the driving scenario is that a vehicle in-use operates in a speed of 40 miles per hour with a 100-feet trailing distance to the front direct leading vehicle. Such a driving scenario is identified as a risky one, because 180 feet is a minimum safe following distance under 40 MPH. After comparing the minimum safe following distance and the real-time sensing distance acquired from the vehicle in-use, this real-time driving scenario is determined to be in a dangerous driving condition. Moreover, the determination of whether a driving scenario is dangerous or not does not only depend on the trailing distance, but the speed as well. For example, when the driving speed is faster than the regulated speed limit, the vehicle in-use is classified to be in dangerous driving condition. As a result, the system might propose a sensitive driving scenario as a combination of trailing distance and driving speed.

Although a driving scenario can be used to identify a dangerous driving behavior, it might happen infrequently or even scarcely. Therefore, the system considers not only the driving scenario itself, but the happening frequency as well. In other words, the system should consider how likely the driving scenario will happen, which is referred to as an occurrence rate of the driving scenario. The occurrence rate is as essential as the scenario itself. In the present invention, a risk classification algorithm may statistically analyze the driving scenario and its occurrence rate to conclude the risk level of the driving scenario. The calculation of the occurrence rates in the risk classification algorithm will be explained in following paragraphs.

In one embodiment, the aforementioned occurrence rate of the driving scenario is determined based on the sensing data with time or milage stamp stored in the historical database 20. The driving period for determining an occurrence rate of the driving scenario may be measured by driving distance or driving time. Firstly, the occurrence rate of a driving scenarios may be determined based on the driving distance. For example, the occurrence rate can be calculated by a proportion of the total driving distance for a journey of the vehicle where the vehicle's sensor signifies a risky condition, such as short trailing distance with the front car, driving in a hazardous area, over/under steering, and spinning, etc. The above distance-domain calculations could be done by using the GPS sensor information (location stamps acquired from the GPS sensor), or other distance related sensors. Secondly, the occurrence rate of a driving scenario can be determined based on the driving time. For example, a proportion of the total driving time for the journey of the vehicle when the vehicle's sensor signifies a sudden acceleration change, skidding, over/under steering, and spinning, etc. The driving time information may be acquired from time-domain sensors, such as a driving-mode sensor with time stamps.

In the present invention, the accident records can be categorized according to the severity of accidents, such as financial losses, damages and injuries caused by the accidents. The historical database 20 can store the sensing data, driving mode information, time/location stamps, and accident records for the analysis of accidental severity by using a clustering algorithm. Therein, more relevant factors can be considered for the analysis, such as transportation regulations, weather condition, and geographic features, etc.

In the present invention, a human control mode is a mode wherein the operator of a vehicle is manually in charge of controlling the vehicle, while an autonomous mode is a mode wherein an autonomous system of the vehicle is automatically in charge of controlling the vehicle. In between, a hybrid mode is a mode wherein switches occurs between manual and automatic modes. Therein, the system of the present invention can compare the expected risks of accidents under different driving modes for the vehicle in-use. For example, When the risk profile of a vehicle in-use states that the expected risk of accidents for human control mode is greater than that for autonomous mode, the system will suggest a switch to autonomous mode. Otherwise, staying in human control mode is optimal.

For example, when the operator gets tired, which can be signified by a real-time image sensor, the past suggestion was pulling over the vehicle. However, when operating on a highway in an isolated area without a nearby rest stop, the operator may be forced to keep a long-distance driving in a dangerous condition. In the present invention, the system compares the expected risks of the accidents between human control and autonomous modes, and then further suggests a switch to the less risky autonomous mode to make sure that the vehicle keeps running in a safer condition until the arrival at the next stop.

Or, when the vehicle enters an unfamiliar and hazardous area, which may be signified by GPS or location-based sensors, the system compares the real-time expected risks of accidents for both driving modes, the system may suggest a switch into the human control mode to enable the operator to manually control the vehicle such that the operator can respond in a timely manner to avoid possible misjudgment by the autonomous driving.

In one embodiment, the expected risks of accidents for the vehicle in-use are highly positively correlated with the vehicle's insurance premiums for different driving modes. A risk profile for the vehicle in-use can be reported by the system to include insurance pricing algorithms, formulas, or charts to map the expected risks of accidents to insurance premiums for different driving modes respectively.

Further, the optimal driving mode can be determined in terms of insurance premium, with reference to the risk profile for the vehicle in-use. That is, the system of the present invention may propose different insurance premiums for different driving modes respectively based on the risk profile for the vehicle in-use, and suggest an optimal driving mode with minimum insurance premium in terms of financial expenditure. Besides, vehicle operators might have their own customized insurance pricing arrangement with an insurance firm providing such a dynamic risk profile for them. Even under the same driving scenarios, different operators can have different insurance pricing, while the present invention can correspondingly provide each operator with insurance cost as lower as possible, according to operator's risk profile under different driving modes.

In one embodiment, the vehicle may operate in both human control and autonomous modes with time/location stamps recorded. In other words, the vehicle operates in a hybrid mode with mode-switching activities occurred frequently. The insurance premium for each mode should be priced first based on the expected risk of accidents under different driving modes respectively. Then the final insurance premium would be the time weighted average of insurance premiums under both driving modes. For example, we denote the insurance premium for human control mode as P_{H}, and denote that for autonomous mode as P_{A}. If the vehicle has been operated in human control mode for T_{H} hours, and in autonomous mode for T_{A} hours, the final insurance premium for the vehicle in-use, denoted by P*, would be the time weighted average of P_{H} and P_{A}. The formula can be shown as P*=(T_{H}/(T_{H}+T_{A}))*P_{H}+(T_{A}/(T_{H}+T_{A}))*P_{A}. The pricing formula for the insurance premium could also be presented as distance weighted average of P_{H} and P_{A}, in terms of distance the vehicle has traveled for, such as milage. In short, the final insurance premium can be determined according to practical needs by using various calculation methods.

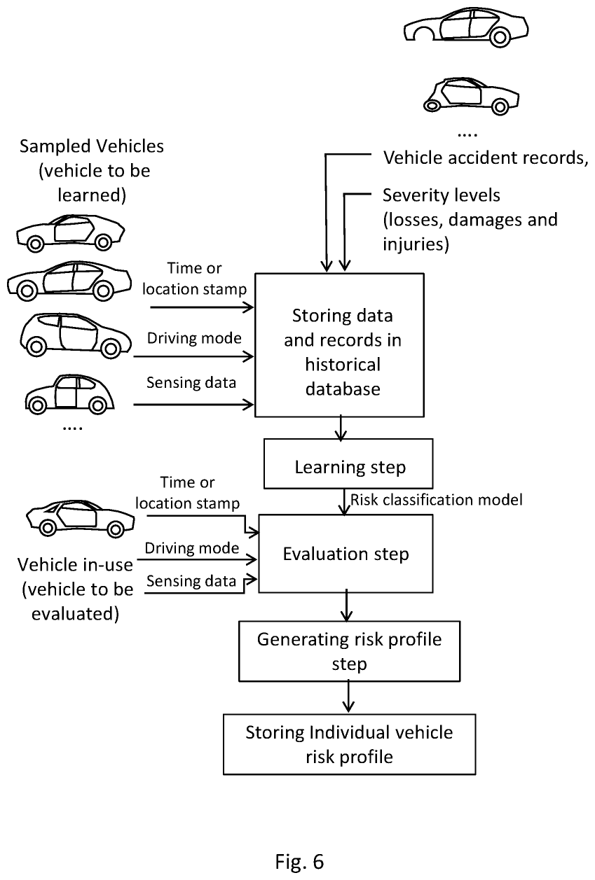

As shown in FIG. 6, in one perspective of the present invention, a vehicle risk analysis method is provided to include: storing the sensing data and accident records acquired from multiple sampled vehicles as big data into a historical database; learning to predict the expected risk of accidents for different driving modes by analyzing the relationship between accident records and driving scenarios in the big data using a risk classification algorithm, to generate a risk classification model validating the relationship between risks of accidents and driving scenarios, wherein each of the driving scenarios is determined by a combination of the sensing data; evaluating the expected risk of accidents using the derived risk classification model and the information of sensing data acquired from the vehicle in-use, to generate a risk profile for the vehicle in-use; and storing the risk profile for the vehicle in-use. For the details of the vehicle risk analysis method, please refer to other embodiments' description.

In one embodiment, the learning step may include: determining sensitive driving scenarios likely impacting subsequent vehicle accidents, and proposing a risk classification model to validate the relationship between driving scenarios and accident records. In one embodiment, the evaluation step may include: determining the expected risk of accidents based on sensing data acquired from the vehicle in-use. In one embodiment, the evaluation step determines the risk profile, which can be further used to price the relevant insurance premiums under different driving modes.

The present invention has been described in more details with reference to certain preferred embodiments thereof. It should be understood that the description is for illustrative purpose, not for limiting the scope of the present invention. Those skilled in this art can readily conceive variations, combinations and modifications within the spirit of the present invention.

What is claimed is:

1. A vehicle risk analysis system, wherein the vehicle includes a plurality of sensors, for respectively generating a plurality of sensing data, the vehicle risk analysis system comprising:
a historical database, storing the sensing data and accident records acquired from multiple sampled vehicles;
a learning unit, connected to the historical database for analyzing a relationship between the accident records and driving scenarios, for generating a risk classification model validating the relationship between risks of accidents and driving scenarios under different driving modes, wherein each of the driving scenarios is determined by a combination of the sensing data; and
a risk profiling unit, receiving the risk classification model from the learning unit and the corresponding sensing data acquired from the vehicle in-use, to generate a risk profile of the vehicle in-use under different driving modes.

2. The vehicle risk analysis system of claim 1, wherein driving modes include human control, autonomous, and hybrid modes; wherein an optimal driving mode for the vehicle in-use is determined according to the risk profile, which is generated by a risk classification model using the sensing data acquired from the vehicle in-use, and the risk classification model is obtained by analyzing the sensing data and accident records acquired from various sampled vehicles using a risk classification algorithm; wherein an optimal driving mode is the mode for the vehicle in-use with minimum expected risk of accidents.

3. The vehicle risk analysis system of claim 2, wherein a sensitive driving scenario is determined by a risk classification algorithm to identify driving scenarios that are more likely to result in vehicle accidents, wherein the sensitive driving scenario may be any combination of the following sensing data, to include trailing distance between the vehicle and its front object, sudden vehicle acceleration change, difference between braked wheel speeds, difference between speeds of not-braking wheels, difference between a vehicle yaw angle and a corresponding steering angle, driving in a hazardous area, over/under speeding, over/under driving, vehicle mechanical component health condition, and vehicle maintenance records.

4. The vehicle risk analysis system of claim 3, wherein the trailing distance between a driving vehicle and its front object, is determined by comparing sensing results of a LIDAR (light detection and ranging) and an image sensor by using a sensor fusion algorithm.

5. The vehicle risk analysis system of claim 1, wherein the sensing data may include: driving speed, milage, time stamp, location stamp, driving mode information, wheel braking condition, turn signal light condition, steering angle, gyroscope angle, parking alarm light, GPS (global positioning system) location, laser radar sensing distance, reversing alarm light, recorded vehicle's outside image, intake air temperature, throttle valve mode, cooling water temperature, oxygen sensing signal, crank angle, air flow, knock sensing signal, tire temperature, and tire pressure, etc.

6. The vehicle risk analysis system of claim 1, wherein a driving period for storing and recording the sensing data acquired from sampled vehicles or a vehicles in-use in the database, is measured by driving distance or driving time.

7. The vehicle risk analysis system of claim 1, wherein the risk profile for the vehicle in-use is used to price an insurance premium, based on the expected risks of accidents under different driving modes for a vehicle in-use.

8. A vehicle risk analysis method, comprising:
storing sensing data and accident records acquired from multiple sampled vehicles;
analyzing a relationship between accident records and driving scenarios, stored as big data, by using a risk classification algorithm to generate a risk classification model, wherein each of the driving scenarios is determined by a combination of the sensing data; and
generating a risk profile for the vehicle in-use, based on the sensing data acquired from the vehicle, wherein the risk profile reports the expected risks of accidents under different driving modes for a vehicles in-use, and the expected risks of accidents is derived by combining occurrence rates of driving scenarios and expected losses of money caused by accidents.

9. The vehicle risk analysis method of claim 8, wherein driving modes of the vehicle in-use include a human control mode, an autonomous mode, and a hybrid mode, wherein the vehicle risk analysis method further comprises: determining an optimal driving mode according to the risk classification model and the sensing data acquired from the vehicle in-use, or according to the risk profile for the vehicle in-use, or according to the risk classification algorithm and information from the big data.

10. The vehicle risk analysis method of claim 8, wherein the risk profile for the vehicle in-use is used to price the customized insurance premiums under different driving modes for the vehicle in-use.
